(19) United States
(12) Patent Application Publication
(10) Pub. No.: US 2009/0251151 A1
(43) Pub. Date: Oct. 8, 2009

(54) METHOD FOR EVALUATING BATTERY, AND EVALUATION APPARATUS THEREFOR

(76) Inventor: Takuya MIYASHITA, Okazaki-shi (JP)

Correspondence Address: BIRCH STEWART KOLASCH & BIRCH, PO BOX 747, FALLS CHURCH, VA, 22040-0747, US

(21) Appl. No.: 12/399,787

(22) Filed: Mar. 6, 2009

(30) Foreign Application Priority Data
Mar. 31, 2008 (JP) P2008-092452

(51) Int. Cl. G01N 27/416

(52) U.S. Cl. 324/426

(57) ABSTRACT

A battery evaluation method includes: determining a weighting coefficient to be assigned to each of performance capabilities of a battery for each field of application where the battery is used; making amendments to results of measurement of the respective performance capabilities acquired from the battery by means of the weighting coefficient; summating the weighted results of the respective performance capabilities amended by the weighting coefficient for each field of application to compute an application-specific evaluation value; and evaluating the battery for each application based on the application-specific evaluation value.

### BACKGROUND

1. Field of the Invention

The present invention relates to a battery evaluation method for evaluating a battery according to the field of application as well as to an evaluation apparatus therefor.

2. Description of the Related Art

An electric vehicle that stores electric power in batteries and that runs by utilization of the thus-stored electric power is equipped with many batteries. The batteries used in the electric vehicle are required to have charge capacity that enables performance of running over a long distance in one charging operation and electric power that enables sufficient acceleration of the vehicle.

An increase in the number of batteries to be loaded results in an increase in the weight of the vehicle and imposes restrictions on the internal space of a vehicle compartment; hence, minimization of the volume of batteries to be loaded is required. For these reasons, each of the batteries is required to exhibit and maintain high performance. Therefore, when initial performance exhibited in an initial phase of use decreases by several ratios for reasons of secular changes, the batteries are determined to be inadequate for use with the electric vehicle, and the batteries are usually replaced with new batteries.

Further, the invention of a controller that evaluates deterioration of a battery in real time, to thus control the battery is described in JP-A-2008-24124.

However, even when the battery is replaced, discarding the battery in its present form is very wasteful. Recycling of the battery by pulverization the battery and separation of pulverized components is not easy and imposes heavy loads on the environment.

A battery used in a certain specific field of application is determined to be replaced because it cannot satisfy a requirement for reasons of a drop in performance. However, there is a case where such a battery is considered to have undergone only a reduction in respective initial values of performance by several ratios for reasons of secular changes, degradation stemming from use, and the like, and can be sufficiently used in another field of application. For instance, even a battery whose capacity is determined to be insufficient for use in an electric vehicle and to be replaced is considered to be sufficiently used in the field of application where not-so-high performance is required or the field of application where much importance is not placed on the performance considered to be important for the electric vehicle. For instance, even a battery for use with an electric vehicle that cannot extract heavy current within a short period of time has the potential of being used as an emergency battery, so long as the battery less causes self-discharge and can extract small current for a long period of time.

On the other hand, means for determining how to utilize the battery extracted for replacement has not been available. Even in the invention described in JP-A-2008-24124, the field of application where use of the extracted battery is not suitable and the field of application where the performance of the battery can be effectively utilized cannot be evaluated.

Even when a battery unit consisting of a plurality of batteries (cells) is determined to be nonconforming through measurement, some of the batteries have performance sufficient for use with an electric vehicle. In the related art, however, the batteries are determined to be nonconforming for use in a collective manner and handled as an object of replacement. Moreover, it is conceivable that progress in performance deterioration varies according to locations of the batteries within the battery unit for reasons of a temperature difference. However, a method for detecting the progress and appropriately relocating the batteries has never been available.

### SUMMARY

It is therefore one advantageous aspect of the invention to provide a battery evaluation method that provides the field of application and the manner of use which are suitable for a battery and that facilitates recycling of the battery, as well as providing an evaluating apparatus therefor.

According to an aspect of the invention, there is provided a battery evaluation method is constituted by comprising determining a weighting coefficient to be assigned to each of performance capabilities of a battery for each field of application where the battery is used; making amendments to results of measurement of the respective performance capabilities acquired from the battery by means of the weighting coefficient; summating the weighted results of the respective performance capabilities amended by the weighting coefficient for each field of application, to thus compute an application-specific evaluation value; and evaluating the battery for each application on the basis of the application-specific evaluation value.

According to another aspect of the invention, there is provided a battery evaluation method is constituted by ranking the battery in a group of batteries on the basis of the application-specific evaluation value and evaluating the battery for each application.

According to still another aspect of the invention, there is provided a battery evaluation apparatus is constituted by comprising a measurement section for measuring respective performance capabilities of a battery; a storage section for storing a weighting coefficient to be assigned to each of performance capabilities measured by the measurement section for each field of application where the battery is used; a weighting section for making amendments to results of measurement of the respective performance capabilities measured by the measurement section by means of the weighting coefficient; a summation section for summating the weighted results of the respective performance capabilities amended by the weighting coefficient for each field of application, to thus compute an application-specific evaluation value; and an evaluation section for evaluating the battery for each application on the basis of the application-specific evaluation value computed by the summation section.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a block diagram showing an embodiment of an evaluation apparatus of the present invention.

### DETAILED DESCRIPTION OF THE INVENTION

An embodiment of a battery evaluation method of the present invention and an evaluating apparatus therefor will be described by reference to the drawings.

The battery is built in the form of a battery unit and set in an electric vehicle. The battery unit consists of about 10 to 40 battery modules, and each of the battery modules is assembled by a combination of about two to ten cells (when a reference is made simply to a word “battery,” the word will herein after refer to a single cell unless otherwise specified), each of which serves as a single unit. The battery module is generally built from a combination of cells of the same type. The number of cells in the configuration is not specifically limited.

The battery is basically a lithium ion battery and can be repeatedly recharged; however, the battery may also be another battery (e.g., a nickel-metal hydride battery). The battery unit is removably seated in the electric vehicle. When the performance of the battery unit fell below a predetermined level, replacement is basically carried out on a per-unit basis.

The battery unit can also be replaced on a per-battery-module basis, and replacement can also be performed on a per-cell basis within the battery module. Basically, the inside of the battery is not subjected to replacement, repair, and the like, and taken as a single cell.

The battery unit is connected to a traveling system of a vehicle by way of an inverter unit, and the like. The traveling system drives an electric motor for traveling purpose by utilization of electric power from the battery unit, thereby causing the vehicle to run. The electric vehicle is equipped with a charging apparatus and an evaluating apparatus. The charging apparatus recharges the battery unit by utilization of electric power supplied from an external power source. The charging apparatus has a measurement device, and the measurement device measures various pieces of information about the battery unit; for instance, information required to charge the charging apparatus. The charging apparatus performs charging operation in accordance with the information. The charging apparatus may also be analogous to a related-art charging apparatus, and its detailed explanations are omitted.

The evaluating apparatus for the battery (the battery unit) will now be described.

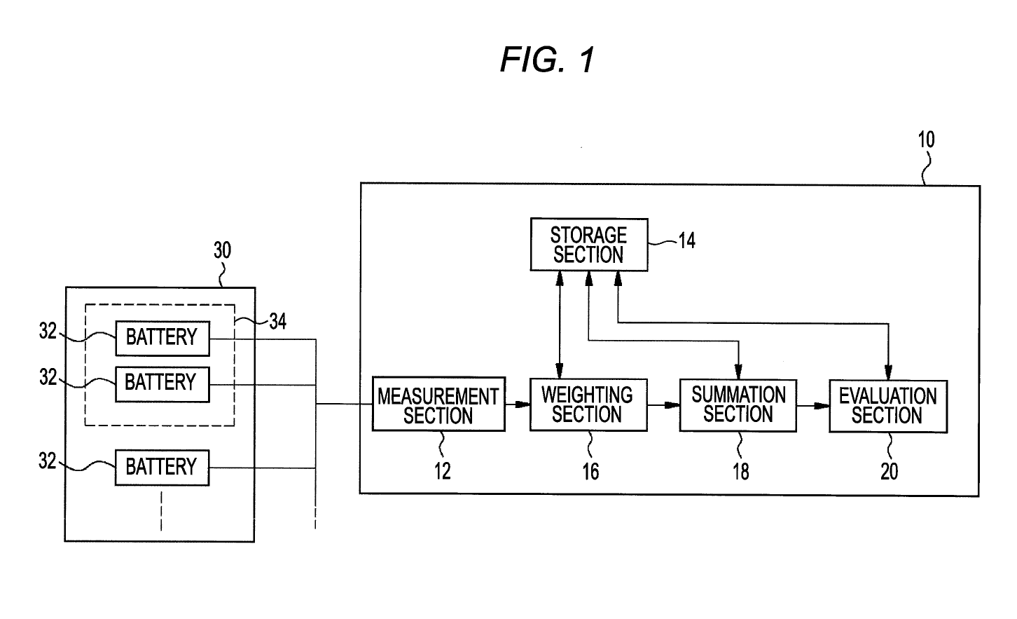

As shown in FIG. 1, an evaluating apparatus 10 is built from a measurement section 12; a storage section 14; a weighting section 16 for imparting a weighting coefficient; a summation section 18; and an evaluation section 20 for evaluating performance.

The measurement section 12 has a plurality of measuring devices (not shown), and the measuring devices are connected to the respective batteries. The measurement section 12 measures performance of respective batteries 32 housed in a battery unit 30. Alternatively, a measuring device may also be provided for each of the battery modules 34, to thus measure the performance of the battery modules, or one or several measuring devices may also be sequentially connected to the respective batteries 32, to thus measure the performance of all of the batteries 32.

The performance to be measured by the measuring device includes charge capacity achieved at the time of full charge of the battery 32, an internal resistance value, a self-discharge level, a charge time elapsing before achievement of a predetermined voltage, and the like. From the viewpoint of grasping the performance of the batteries 32 from many aspects, measuring a plurality of types of performance is preferable, so long as the performance represents the capability of the batteries 32. The measuring devices perform measurement, as necessary, in accordance with performance even when the batteries are in standby condition, as well as performing measurement when the batteries 32 are in the course of discharging and being recharged. Performance continually measured with time as well as results immediately acquired at points in time when measurement is carried out are also measured. The measurement section 12 sends the results measured by the measuring devices to the weighting section 16.

The storage section 14 stores weighting coefficients to be imparted in connection with respective performance capabilities. The weighting coefficient is a factor set for each type of the battery 32 and determined according to the field of application where the battery 32 is intended to be used. Specifically, a determination is made for each field of application as to whether or not performance is considered to be important in that field of application. In relation to performance considered to be important, a weighting coefficient for that performance is increased. In contrast, in relation to performance considered to be less important, a weighting coefficient for the performance is decreased. Hereby, measurement results pertaining to important performance greatly affect the evaluation of the batteries 32 to be described later.

For instance, in order to use batteries in an electric vehicle, the batteries are required to extract a heavy current for a long period of time. Consequently, weighting coefficients relating to performance, such as charge capacity and an internal resistance value, are set to comparatively-large values. In the meantime, performance, such as a self-discharge, is not determined to be important because the batteries are usually charged only a daily basis; hence, a weighting coefficient for this performance is set to a comparatively-small value.

On the contrary, when the batteries are used in the field of application, such as a hospital, or used as an emergency power source or in outer space, the batteries are required to be able to stably operate at light load for a long period of time in many cases. Therefore, performance pertaining to self-discharging operation, and the like, is determined to be important, and a weighting coefficient for such performance is set to a comparatively-large value. Conversely, weighting coefficients for performance pertaining to charge capacity and an internal resistance value are set to comparatively-small values.

As mentioned above, in relation to performance determined to be important when the batteries are used for a certain field of application, a weighting coefficient assumes a large numeral so as to be greatly reflected on evaluation of the batteries 32. A weighting coefficient imparted to performance determined to be less important assumes a small value so as not to greatly affect evaluation of the batteries. The magnitude of the weighting coefficient is not limited to these rules, and there is also a case where magnitudes of weighting coefficients are set in the reverse of the rules according to an evaluation method for comprehensive evaluation.

The weighting section 16 makes an amendment to a performance result (e.g., a score, a rank, and the like) acquired through measurement performed by the measurement section 12 by means of the weighting coefficient read from the storage section 14. Since the weighting coefficient is set for each field of application, a result of weighting amended by the weighting coefficient also shows a performance result computed for each field of application. The result of weighting amended by the weighting section 16 is sent to the summation section 18 for each field of application.

The summation section 18 summates the results of weighting sent form the weighting section 16 for each field of application, thereby computing evaluation values of the respective batteries for each field of application. Evaluation values of the batteries 32 are thus computed for each field of application. Such an evaluation value for each field of application is computed in connection with all of the batteries 32 housed in the battery unit 30. Computed results are sent to and stored in the storage section 14. Since the measurement section 12 continuously measures performance of the respective batteries 32, the evaluation values for respective fields of application are changed at all times on the basis of the measurement results.

The evaluation section 20 ranks the batteries 32 on the basis of an application-specific evaluation value computed by the summation section 18. Various ranking methods are available for ranking; for instance, a method for ranking the respective batteries 32 in terms of an application as to which application is suitable for each battery 32; ranking the respective batteries 32 in terms of an application while the battery unit 30 is taken as a unit and while all of the batteries 32 housed in the battery unit 30 are taken as objects of ranking; a common-ranking method for enabling making of a determination as to the batteries 32 of the same type including another battery unit 30.

The evaluation section 20 subjects the respective batteries 32 to various ranking operations on the basis of the application-specific evaluation value and stores ranking results in the storage section 14. When a desire for using the results for a certain objective is input, the evaluation section 20 withdraws ranking suitable for the desire from the storage section 14; sorts and ranks the respective batteries 32; and sends sorting and ranking results.

The thus-acquired ranking results are stored in memory (not shown) provided in the battery unit 30. It is desirable to enable reading of the results from memory, as necessary, even after removal of the battery unit 30 from the electric vehicle. Each of the batteries 32 may also be equipped with memory, and raking results may also be stored in the memory devices.

This makes it possible to determine the field of application for which each of the batteries 32 is suitable on the basis of the application-specific evaluation value. As a result of the battery being used in the thus-determined field of application, the battery 32 can be used again as the battery 32 exhibiting high performance.

In the battery unit 30, the batteries 32 unsuitable for use in the electric vehicle can be determined on the basis of the application-specific evaluation value. Such a battery 32 can be relocated within the battery unit 30 or replaced with another battery 32 having performance suitable for use with the electric vehicle. Thus, the battery unit 30 can be again continuously used as a result of replacement of some of the batteries 32.

Further, the thus-replaced batteries are sorted on the basis of the application-specific evaluation value, thereby gathering the batteries according to an application. A battery module or a battery unit tailored to each type of field of application can thus newly configured.

### Embodiment

A method for evaluating the batteries 32 using the evaluation apparatus will now be described specifically.

The battery unit 30 is assumed to be used in an electric vehicle (herein after referred to as a “vehicle”). The vehicle is equipped with an electric motor for traveling purpose (not shown) and the battery unit 30 and drives the motor by utilization of power from the battery unit 30, to thus run. The vehicle is assumed to recharge the battery unit 30 by utilization of external power during a time period in which the vehicle is not used; for instance, in the nighttime.

The battery unit 30 consists of about 100 batteries (cells) 32. Each of the batteries 32 is equipped with a measurement device, by means of which performance of the battery 32 is measured. The performance of the batteries 32 is measured at all times. A result of performance is represented in the form of a score, and a higher score is assumed to represent a better result. Charge capacity is classified into; for instance, five levels from a highest charge capacity level for the battery 32 to a capacity level where the battery is determined to be unavailable. The highest level is given a score of 20; the next level is given a score of 15; and the lowest level is given a score of 0.

The storage section 14 stores weighting coefficients. A weighting coefficient is set for each performance according to the degree of importance in the field of application. For instance, in a case where the field of application of the battery is an electric vehicle, large weighting coefficients are set for charge capacity, an internal resistance value, and the like. In the meantime, a small weighting coefficient is set for a self-discharge value.

A different numeral is set for the same performance, so long as the field of application is different. For instance, the field of application is a hospital, and the like, where the battery is used for the purpose of driving a power-thrifty motor for a long period of time, small numerals are set for charge capacity, an internal resistance value, and the like, and a large numeral is set for a self-discharge value, and the like.

For instance, in relation to results of measurement of the first battery performed by the measurement section 12, charge capacity is given a score of 10; an internal resistance value is given a score of 5; and a self-discharge level is given a score of 20. In relation to results of measurement of the second battery performed by the measurement section 12, charge capacity is given a score of 15; an internal resistance value is given a score of 10; and a self-discharge level is given a score of 10.

A value of the performance measured by the measurement section 12 is unique to the battery 32 and common to the fields of application. The total score of the first battery is 35, and the total score of the second battery is also 35. When the scores for the measurement results are simply summated, the first battery and the second battery assume the same score.

However, the first battery and the second battery are different from each other in terms of the results of measurement of performance; hence, it is manifest that the batteries are superior in one field of application but inferior in another field of application. Accordingly, amendments are made to the results for each field of application by means of weighting coefficients. For example, in relation to weighting coefficients for use in a case where the field of application of the batteries is an electric vehicle, the score for charge capacity and the score for an internal resistance are tripled whilst the score for the self-discharge level is reduced to one-half as large as its original score. In the meantime, in relation to weighting performed in a case where the field of application of the batteries is a hospital, the score for charge capacity and the score for the internal resistance value are made 0.5 times as large as their original values, and the score for the self-discharge level is tripled.

The score of the first battery used for an electric vehicle comes to 55, and the score of the same used for a hospital comes to 67.5. In the meantime, the score of the second battery used for an electric vehicle comes to 80, and the score of the same used for a hospital comes to 42.5.

From a comparison between the score acquired when the battery is used for an electric vehicle and the score acquired when the battery is used for a hospital, the first battery is understood to be suitable for use in a hospital. Moreover, from a comparison between the score acquired when the battery is used for an electric vehicle and the score acquired when the battery is used for a hospital, the second battery is understood to be suitable for use in an electric vehicle.

Moreover, a comparison between the first battery and the second battery shows that the second battery is more suitable for use in an electric vehicle than is the first battery and that the first battery is more suitable for use in an electric vehicle than is the second battery. Thus, even in the case of batteries assuming the same score obtained through simple summation of scores determined from results of measured performance of the batteries, a field of application suitable for each of the batteries is determined by means of weighting the score for each performance. The batteries are sorted for respective fields of application on the basis of the thus-acquired results, whereby the batteries can be used as having sufficient performance required in the field of application.

Although two fields of application are described in connection with the embodiment, the present invention is intended for a larger number of fields of application, such as a case where a battery is used for a toy, a case where a battery is used for illumination, and the like. Further, the items for evaluating a battery have been described by reference to the charge capacity, the internal resistance value, and the self-discharge level. However, the items are not limited to them. Any items are available, so long as the items enable evaluation of a battery, such as a capacitance maintenance factor, a rate of an increase in internal resistance, a rate of expansion of a battery, a rate of increase in self-discharge, the shape of a discharge curve, and the like. Although the result of measurement is expressed in the form of a score, evaluation may also be performed on the basis of the ranks assigned to the batteries. Although weighting of important performance is increased, the manner of weighting is not limited to an increase. Further, although an explanation has been provided in the above embodiment by means of taking the electric vehicle as an example, the present invention is not limited to the electric vehicle. The present invention may also be applied to any vehicle, so long as the vehicle is of a battery-driven type, such as a hybrid electric vehicle and a plug-in hybrid vehicle. Depending on the field of application, a battery that fails to exhibit performance of a predetermined value or more in connection with a specific evaluation item may also be eliminated from objects of comparative examination without being subjected to weighting.

Although the evaluation apparatus is mounted in the electric vehicle in the embodiment, the location of the evaluation apparatus is not limited to the inside of the vehicle, and the evaluation apparatus may also be set at another location according to the present invention. For instance, the evaluation apparatus may also be set at a location other than the location where the electric vehicle is used, and batteries removed from the location of use may also be evaluated by means of the evaluation apparatus.

According to the above, performance of a battery is evaluated for each field of application. On the basis of an evaluation value determined for each field of application, the field of application of the battery is selected, so that the battery can be used in the most suitable field of application. It becomes possible to rank each of batteries within a group of batteries for each field of application, thereby making it easy to constitute a group of batteries (a battery unit, and the like) to be used for a specific field of application.

A battery not suitable for a certain field of application is changed to another field of application, whereby use of the battery becomes possible. Thus, the field of application of the battery is enlarged, and waste of the battery can be eliminated.

A plurality of batteries can be ranked for a case where the batteries are used in a certain field of application. As a result, it becomes possible to select and provide high-performance batteries to a client who requests high performance. In contrast, low-ranked batteries are selected for a client who desires low-performance batteries, and prices can also be set according to performance. Thus, batteries are sorted according to performance, whereby clients' requests can be appropriately satisfied.

In an electric vehicle, a battery is selected according to performance required for an electric vehicle; for instance, according to the type of a family-oriented vehicle and a sport-oriented vehicle, and the electric vehicle can be characterized by means of batteries (a battery unit). Moreover, degradation of respective batteries can be averaged by appropriately arranging the batteries within the battery unit, so that a time elapsing before a battery unit reaches its limits, and the like, can be extended.

What is claimed is:

1. A battery evaluation method comprising:
determining a weighting coefficient to be assigned to each of performance capabilities of a battery for each field of application where the battery is used;
making amendments to results of measurement of the respective performance capabilities acquired from the battery by means of the weighting coefficient;
summating the weighted results of the respective performance capabilities amended by the weighting coefficient for each field of application to compute an application-specific evaluation value; and
evaluating the battery for each application based on the application-specific evaluation value.

2. A battery evaluation method comprising:
determining a weighting coefficient to be assigned to each of performance capabilities of a battery for each field of application where the battery is used;
making amendments to results of measurement of the respective performance capabilities acquired from the battery by means of the weighting coefficient;
summating the weighted results of the respective performance capabilities amended by the weighting coefficient for each field of application to compute an application-specific evaluation value; and
ranking the battery in a group of batteries for each field of application based on the application-specific evaluation value.

3. A battery evaluation apparatus comprising:
a measurement section, configured to measure respective performance capabilities of a battery;
a storage section, configured to store a weighting coefficient to be assigned to each of performance capabilities of a battery measured by the measurement section for each field of application where the battery is used;
a weighting section, configured to make amendments to results of measurement of the respective performance capabilities of the battery measured by the measurement section by means of the weighting coefficient;
a summation section, configured to summate the weighted results amended by the weighting section for each field of application to compute an application-specific evaluation value; and
an evaluation section, configured to evaluate the battery for each application based on the application-specific evaluation value computed by the summation section.
